(19) United States
(12) Patent Application Publication
(10) Pub. No.: US 2007/0174112 A1
(43) Pub. Date: Jul. 26, 2007

(54) Systems and methods for ticketless parking validation

(76) Inventor: Peter N. Thorson, Santa Monica, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/338,087

(22) Filed: Jan. 24, 2006

(51) Int. Cl. G07B 15/00

(52) U.S. Cl. 705/13

(57) ABSTRACT

Methods, systems, and software for ticketless parking validation. A method comprises creating an electronic parking account associated with a use of a parking facility, electronically storing at least one credit amount, and associating the at least one credit amount with the electronic parking account as a result of identifying the electronic parking account with an identifier.

### BACKGROUND OF THE INVENTION

1. Field of the Invention

The invention relates to a parking fee collection system. More particularly, the invention relates to a parking fee collection system implementing ticketless parking validation.

2. Description of the Related Art

Presently, parking fee collection services are implemented with automated, ticketless transactions. In some services, a visitor to a parking facility swipes a valid credit and/or debit card to enter the facility, eliminating the need for taking a time-stamped ticket from, for example, an automatic dispenser. Upon exiting the parking structure, the visitor swipes the same credit card, the parking fee collection service calculates the parking fee, and the resulting fee is then charged to the visitor's credit card. Thus, it is presently known how to implement “ticketless” transactions. One problem with present ticketless parking systems, however, is that they do not allow for parking validation. This may be inconvenient for businesses, and possibly other entities, who may wish to provide parking validation for their patrons in order, for instance, to attract customers to their location where parking costs might otherwise discourage patronization.

It is also presently known how to implement a parking fee collection service with a ticket validation system. In some services, businesses, or other entities, associated with the parking facility may provide parking visitors with validating tickets if the parking visitor, for example, purchases an item for sale by the validating entity. Upon exiting the parking facility, the parking visitor then may return the validating ticket to an attendant who discounts at least a portion of the visitor's incurred parking fee. One problem with current ticket validation systems is that they require human labor, which may be expensive, and cash handling, which may be dangerous to the human attendants. Another problem with current ticket validation systems is that they require, for example, paper tickets and/or paper validation stickers or coupons, which may be expensive to produce in the long run and which, furthermore, may be inconvenient to use, especially because parking visitors must keep track of the paper items.

Hence, there is a need to improve parking fee collection services.

### SUMMARY OF THE INVENTION

The need to improve parking fee collection services is satisfied by providing methods, systems, and software for implementing ticketless parking validation. For instance, ticketless parking validation may be implemented by a method comprising creating an electronic parking account associated with a use of a parking facility, electronically storing at least one validating credit amount originating from a validating entity, and associating the at least one validating credit amount with the electronic parking account as a result of the validating entity providing an identifier for the electronic parking account.

Ticketless parking validation may also be implemented by a method comprising receiving automatically a payment account identifier as a condition for permitting a user to use the automatic parking facility, determining an unadjusted fee for the user's use of the parking facility, receiving automatically at least one validating credit amount, and determining at least one adjusted fee for the user's use of the parking facility based on the at least one validating credit amount and on the unadjusted fee for the user's use of the parking facility.

Ticketless parking validation may also be implemented with certain systems. For instance, a system implements ticketless parking validation by providing at least a first parking terminal, at least a first validating terminal, and a ticketless parking validation device in data communication with the at least first parking terminal and the at least first validating terminal. The at least first parking terminal is configured to receive and to communicate at least one payment account identifier associated with at least one use of a parking facility. The at least first validating terminal is configured to receive and to communicate the at least one payment account identifier and at least one credit amount associated with the at least one payment account identifier. The ticketless parking validation device is configured to receive from the at least first parking terminal the at least one payment account identifier, and is further configured to receive from the at least first validating terminal the at least one payment account identifier and the at least one credit amount.

A system also implements ticketless parking validation by providing a ticketless parking validation device in data communication with at least one parking terminal and at least one validating terminal. The ticketless parking validation device is configured to receive from the at least one parking terminal at least one payment account identifier associated with at least one use of a parking facility. The ticketless parking validation device is further configured to receive from the at least one validating terminal the at least one payment account identifier and at least one credit amount associated with the at least one payment account identifier.

A system also implements ticketless parking validation by providing a validating terminal configured to receive from a user and to communicate to a ticketless parking validation device at least one payment account identifier and at least one credit amount associated with the at least one payment account identifier.

Ticketless parking validation may also be implemented in software. For instance, ticketless parking validation may be implemented by a computer readable medium having machine loadable software. The software is configured to perform a method comprising storing an identifier received in a transmission from a parking terminal device, searching for the identifier in response to receiving the identifier in a transmission from a validating terminal device, and storing at least one validating credit amount received in a transmission from a validating terminal device, wherein storing at least one validating credit amount comprises storing the at least one validating credit amount in association with the identifier.

### BRIEF DESCRIPTION OF THE DRAWINGS

FIG. 1 illustrates a parking fee collection system implementing ticketless parking validation.

FIG. 2 illustrates the operations of various components in one embodiment of the invention when a parking visitor enters the parking facility.

FIG. 3 illustrates the operation of various components in one embodiment of the invention when a validating entity credits the account of a parking visitor.

FIG. 4 illustrates the operation of various components in one embodiment of the invention when a parking visitor exits the parking facility.

FIG. 5 illustrates the flow of information in one embodiment of the invention.

FIG. 6 illustrates the data components in one embodiment of an electronic parking account that may be used to implement the invention.

### DETAILED DESCRIPTION OF THE PREFERRED EMBODIMENT

Various aspects and features of the invention will be more fully apparent from the following description and appended claims taken in conjunction with the foregoing drawings. In the drawings, like reference numerals indicate identical or functionally similar elements. Drawings, associated descriptions, and specific implementation are provided to illustrate preferred embodiments of the invention and not to limit the scope of the invention.

In general, the preferred embodiments relate to methods, systems, and software for implementing ticketless parking validation. For many reasons, it is advantageous to provide automated parking systems. In these systems, an automated parking fee collection service is utilized, eliminating the need for facility attendants to handle cash. Employing parking attendants is an expensive operating cost for parking facility owners, and cash handling may pose a significant threat to the safety of employee attendants. For other additional reasons, it is advantageous to implement parking validation in a parking fee collection service, giving commercial entities, such as shopping mall retail stores, the opportunity to reduce the expense of their customers' parking costs. One purpose of the present invention is to provide a parking fee collection service that captures the advantages of automated parking systems and of validating parking systems. Preferred embodiments of the invention implement ticketless parking validation.

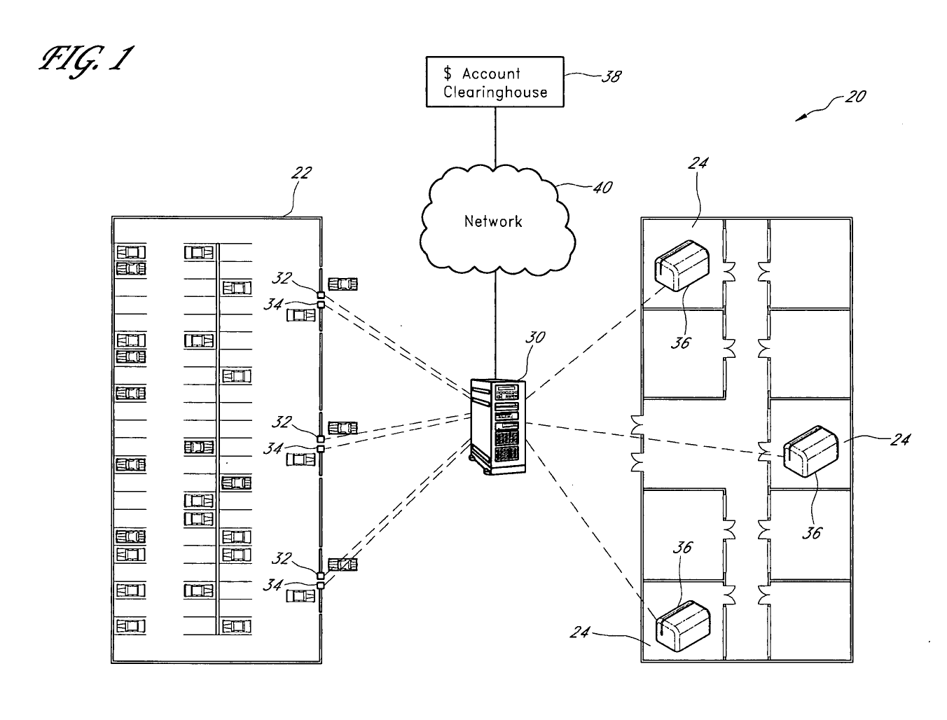

FIG. 1 illustrates an embodiment of a parking fee collection system 20 implementing ticketless parking validation. In the illustrated embodiment, the parking fee collection system 20 collects fees from visitors who use a parking facility 22. Visitors may receive credits from validating entities 24, such as business occupants in an office building or retail stores in a shopping mall, and these credits may be applied to a visitor's respective parking fee.

As a result of the communication and configuration of the component devices, the illustrated parking fee collection system 20 implements the validation service without the need for distributing validating tickets to parking visitors. In the illustrated embodiment, the fee collection system 20 is implemented with a ticketless parking validation device 30, which is in communication with several in-parking terminals 32, several out-parking terminals 34, and several validating terminals 36. In addition, the ticketless parking validation device 30 is connected with an account clearinghouse 38 via a network 40.

To implement ticketless validation, the parking fee collection system 20 identifies each visitor to the parking facility 22 with an identifier, typically a payment account identifier. The following brief discussion describes how, in the embodiment illustrated in FIGS. 1 through 6, the various components of the parking fee collection system 20 implement ticketless transactions by tracking a visitor to the parking facility 22 via a payment account identifier. Upon entering through one of the in-parking terminals 32, a visitor submits a payment account identifier. The ticketless parking validation device 30 creates an electronic parking account for the visitor and stores as one of its fields the visitor's payment account identifier. Any information regarding the visitor's use of the parking facility 22, such as the time when the visitor entered the parking facility 22, is also stored in the visitor's electronic parking account. While using the parking facility 22, the visitor may accumulate credits from validating entities 24, and the accumulated credits may be applied to the visitor's respective fee for using the parking facility 22. Validating entities 24 submit credit amounts to the ticketless parking validation device 30 through the validating terminals 36. The ticketless parking validation device 30 locates the visitor's electronic parking account by searching for the visitor's payment account identifier, which the validating entities 24 also submit through the validating terminals 36, and stores the respective credit amounts in the visitor's electronic parking account. Upon exiting the parking facility 22 through one of the out-parking terminals 34, the ticketless parking validation device 30 locates the visitor's electronic parking account by searching for the visitor's payment account identifier, which the visitor enters through one of the out-parking terminals 34, calculates the visitor's parking fee based on the amount of time the visitor used the parking facility 22 and the accumulated credit amounts from the validating entities 24, and charges the fee to the visitor. As illustrated in FIG. 1, the ticketless parking validation device 30 communicates via the network 40 with an account clearinghouse 38, which verifies that the visitor's payment account identifier is valid and charges the parking fee to the identified payment account.

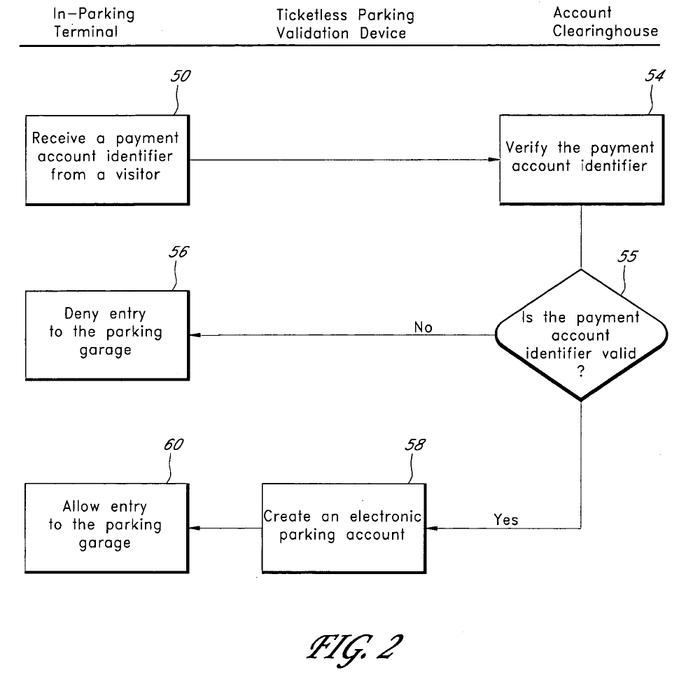

Additional details of the above-described embodiment will be discussed further below with reference to FIGS. 2 through 6. Ticketless parking validation may be implemented in various alternative embodiments. Some of these variations are discussed immediately below and others are discussed further below with reference to FIGS. 2 through 6.

As mentioned above, the embodiment illustrated in FIGS. 1 through 6, keeps track of a parking visitor's transactions via a payment account identifier. A payment account identifier is any identifier, alphanumeric or otherwise, that may be used to track the payment of parking fees incurred for a particular visit, or even set of visits, to the parking facility 22. Thus, the payment account identifier may be, for instance, a credit card number, debit card, or credit/debit card number. Alternatively, the payment account identifier may be a prepaid parking card number. For example, a parking facility 22 may distribute, either locally or remotely, prepaid parking cards, which visitors may purchase to satisfy fees incurred for the use of the parking facility 22. Consistent with other prepaid cards, such as long-distance cards, these parking cards may be kept by visitors and used upon subsequent visits. In these instances, the ticketless parking validation device 30 typically communicates with the account clearinghouse 36 to verify that the account number is a valid account and that there are sufficient funds to which the incurred parking fee may be charged. In the case of credit and debit cards, the account clearinghouse 38 may be an independent financial institution that keeps track of credit/debit card transactions. In the case of a prepaid card, the account clearinghouse 38 may be a service local to the parking garage, which verifies the validity of the prepaid card and charges the incurred parking fee to the visitor's card. Alternatively, the account clearinghouse 38 may be a remote service that manages verification and charges to prepaid cards that operate in multiple parking facilities.

In addition to card numbers, the payment account identifier may also be a number specific to the parking facility 22. For example, the payment account identifier may be a visitor-created PIN number or, alternatively, a PIN number assigned by the parking facility 22. In this instance, the payment account identifier serves only as a means of identifying the parking visitor and may not be used to identify a particular account to which the incurred parking fee is charged. Thus, in this implementation, parking visitors provide means of payment that do not depend upon charging the fee to the account identified by the payment account identifier. There are many possible variations. For example, parking visitors might settle their parking accounts by delivering cash through an automated cash receiver. In this instance, the parking visitor is identified by the user-created PIN upon exit, and subsequently, the parking visitor pays with cash the fee corresponding to the parking account identified by the user-created PIN. In such embodiments, the account clearinghouse 38 may be unnecessary.

In addition to numbers, the payment account identifier may be any identifier stored electronically in order to identify a visitor to the parking facility 22. Thus, the payment account identifier may be biometric in nature, such as a fingerprint or an iris pattern, or may be any other suitable means of personal identification. In these embodiments, the account clearinghouse 38 might verify that the identified visitor is authorized to use the parking facility. In other embodiments, the account clearinghouse 38 might not be necessary, as the parking facility 22 may be open to any visitors and the payment account identifier serves only to keep track of a particular user, not to identify a specific means of verifiable payment.

In the illustrated embodiment, the visitor must enter a valid account before entering the parking facility. One skilled in the art will appreciate that there are many ways in which a parking fee collection service may be implemented. For instance, visitors may be allowed to park without restriction. In these circumstances, patrons are responsible for providing an account at a parking terminal after they have parked. These parking facilities may be regulated periodically in order to ensure that parking visitors are paying for their parking.

In the embodiment illustrated in FIGS. 1 through 6, the parking visitor typically pays the incurred parking fee as a precondition to be allowed to exit the parking facility 22. Other alternative variations are possible. As mentioned above, the payment account identifier may be specific to the parking facility 22, such as a visitor-created PIN number. In these embodiments, parking visitors might be personally billed for the parking fees. For instance, the parking fee collection system 20 might generate automated bills and send those bills to parking visitors by mail, make the bills available for online payment, or require independent payment in some other manner. Thus, in some embodiments, the visitors do not necessarily pay before exiting the parking facility 22, but may pay the incurred parking fee at some later date. In these instances, the ticketless parking validation device 30, or some other device, stores personal billing information for the visitor, such as the visitor's name and address, and the parking fee collection system 20 sends a bill for the incurred fee to the visitor.

In the embodiment illustrated in FIGS. 1 through 6, validating entities 24 communicate various parking credit amounts to the ticketless parking validation device 30 through the validating terminals 36. For instance, one of the validating entities 24, such as a department store, might communicate a validating credit to the ticketless parking validation device 30 after the parking visitor makes a purchase from the respective validating entity 24. As discussed, the ticketless parking validation device 30 stores the validating credit in the visitor's electronic account and discounts the amount of the credit from the parking fee charged to the visitor upon exit. In some embodiments, the validating entities 24 may communicate multiple validating credits for a particular visitor. Additionally, a particular visitor may accumulate validating credits from multiple validating entities 24. Thus, in some embodiments, there is a need for validating entities 24 to monitor the current parking fee balance of a particular visitor. Accordingly, validating entities 24 may view the current status of the parking visitor's account through the validating terminals 36. For instance, one of the validating entities 24 may request from the ticketless parking validation device 30 the current status of the visitor's account. The respective validating terminal 36 identifies the respective visitor by the visitor's payment account identifier, which it communicates to the ticketless parking validation device 30. Then, the ticketless parking validation device 30 communicates to the respective validating terminal 36 the current parking fee balance for the respective visitor, which the respective validating entity 24 may consider in determining the appropriate validating credit amount.

Although not illustrated in this embodiment, validating entities 24 may be configured to communicate directly with the account clearing house 38 through the network 40. In these instances, the validating entities 24 might communicate with the ticketless parking validation device 30 only to ascertain the current status of a visitor's parking fee balance, without communicating the credit amounts. In this instance, the respective validating entity 24 would monitor the current fee balance of the visitor in order to determine an appropriate amount of validating credit. These credit amounts, however, are communicated directly to the account clearinghouse 38, which credits the payment account identified by the payment account identifier. These credits would be intended to offset the full cost of the parking fee, which would be charged to the respective visitor upon exit.

FIG. 2 illustrates the operations of various components in one embodiment of the invention when a parking visitor enters the parking facility. FIG. 2 is divided into three sections, representing the operations of the in-parking terminals 32, the ticketless parking validation device 30, and the account clearinghouse 38.

FIG. 2 illustrates the flow of information in one embodiment of the invention. When a visitor arrives at one of the in-parking terminals 32, the respective in-parking terminal 32 prompts the visitor to input a payment account identifier and, preferably, receives a payment account identifier from the visitor at state 50. One skilled in the art will appreciate that the in-parking terminal 32 may be configured in various ways to receive a payment account identifier. As discussed with reference to FIG. 1, the payment account identifier may be a card number, such as a credit card number, debit card number, prepaid card number, etc. To read the credit card number, the in-parking terminals 32 may, for example, be equipped with magnetic card reader devices. One skilled in the art will appreciate that there are many different kinds of payment account cards and accompanying card readers. Thus, in certain embodiments, the payment account cards may be keycards, smart cards, proximity cards, or any other uniquely identified card. Accordingly, the in-parking terminals 32 may be equipped to read and/or otherwise communicate with cards comprising magnetic strips, bar codes, embedded microprocessors, etc.

Additionally or alternatively, the in-parking terminals 32 may be equipped to receive a payment account identifier from devices other than card readers. In some embodiments, the in-parking terminals may be equipped with an alphanumeric keypad provided at the in-parking terminal 32. In these embodiments, visitors might enter into the keypad card numbers—such as, credit, debit, and prepaid card numbers—or, alternatively, identifiers specific to the parking facility 22. Thus, for example, visitors might enter a personal PIN number created at the time of entry. In still other embodiments, the parking fee collection system 20 might assign each visitor a system-created PIN number upon entering the parking facility 22.

The in-parking terminals 32 may also comprise other devices for receiving an identifier from a key fob, for example, or other hardware devices with built-in authentication mechanisms. It will be appreciated that these authentication mechanisms may utilize any number of means for transmission, including without limitation infrared signals, radio frequency, etc. In some embodiments, the in-parking terminals 32 may be equipped to receive an identifier from a personal device not associated with the parking facility 22. For instance, the payment account identifier may be a unique sound, such as a dial tone or other telephonic signal, emitted, for instance, from a user's personal cellular phone. Moreover, the in-parking terminals 32 may be equipped with a biometric identifier device, such as fingerprint, voice pattern, or iris pattern scanners, or any other means for personally identifying the parking visitor. Other additional information may also be collected at the in-parking terminals 32, such as billing information, including the name and address of the respective parking visitor, which may be used in embodiments where parking visitors are billed in lieu of paying upon exit.

It will be appreciated by one skilled in the art that one implementation of the in-parking terminal 32 is an entry barrier gate, presently a common feature of parking systems. Although in the illustrated embodiment, the in-parking terminals 32 are configured to bar entry, with a parking gate arm, to the parking facility 22 until a payment account identifier is received, in other embodiments, the in-parking terminals 32 may not be positioned at the entryway to the parking facility or even at the parking facility at all. For instance, the in-parking terminals 32 may be implemented as standalone terminals that visitors access after parking in the parking facility 22. In another example, the in-parking terminals 32 may be implemented as remote terminals that receive payment account identifiers through a remote connection, such as a web browser interface over the Internet.

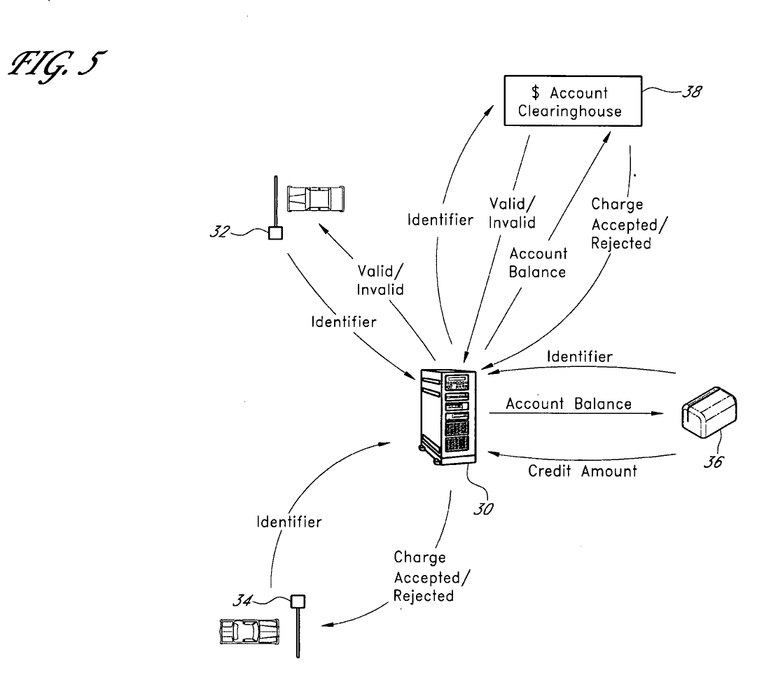

After the respective in-parking terminal 32 receives the payment account identifier, the respective in-parking terminal 32 communicates (described below with reference to FIG. 5) the payment account identifier to the ticketless parking validation device 30, which in turn communicates (described below with reference to FIG. 5) the payment account identifier to the account clearinghouse 38. In state 54, the account clearinghouse 38 verifies the validity of the payment account identified by the payment account identifier. There are many variations for verifying a payment account identifier. The account clearinghouse 38 may be a financial institution that authorizes transactions of credit and debit for various financial accounts, such as a credit card account. Thus, for example, if the payment account identifier is a credit card number, then the account clearinghouse 38 verifies that the credit card number corresponds to a credit card account for which the account clearinghouse 38 is authorized to credit or debit amounts. In this instance, the account clearinghouse 38 is likely a remote institution and the network 40 is likely an open network, such as the Internet or the telephone lines.

In other embodiments, the account clearinghouse 38 may be a local service that verifies the payment account identifier according to the standards required by the parking fee collection system 20. For example, the account clearinghouse 38 might verify that a prepaid parking card distributed by the parking fee collection system 20 is a valid prepaid parking card, not a counterfeit. Moreover, the account clearinghouse 38 may reside on the same machine as the ticketless parking validation device 30, possibly eliminating the need for connection through the network 40. The account clearinghouse 38 may be a function of the same module that implements the described functionality of the ticketless parking validation device 30. In this case, the ticketless parking validation device 30 is a ticketless parking validation module that resides on the same device as an account clearinghouse module.

Alternatively, the account clearinghouse 38 might verify that a user-created PIN number meets certain criteria, such as a minimum or maximum number of characters. Moreover, the account clearinghouse 38 might verify that a visitor's fingerprint or iris scan have been preauthorized as identifiers for authorized parking visitors. Additionally, the account clearinghouse 38 might verify accurate billing information for embodiments that implement automated billing. Furthermore, in some embodiments, the payment account identifier might not be verified and the account clearinghouse 38 would never be used.

Decision block 55 represents the determination of the verification in state 54. If the account clearinghouse payment account identifier is not valid, then the in-parking terminal 32, in state 56, denies entry to the parking garage. In some embodiments, the in-parking terminal denies entry by not taking any action. In other embodiments, the in-parking terminal might be configured to take some positive action to impede entrance to the parking facility 22. Additionally, the in-parking terminal may be configured to display a reason for denying entry, such as “Invalid Account.” In yet other embodiments, the denial is purely conceptual, and the visitor may proceed to park without authorization. In these embodiments, enforcement personnel may be employed to police the parking facility 22.

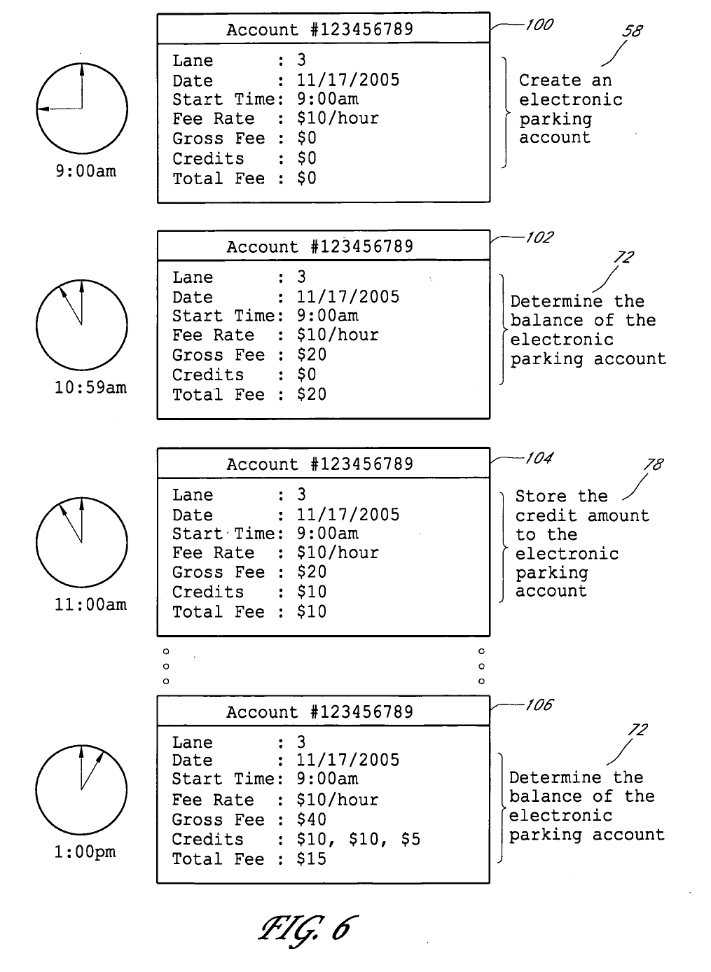

If, on the other hand, the account clearinghouse 38 verifies that the payment account identifier is valid, then, in state 58, the ticketless parking validation device 30 creates an electronic parking account for the respective parking visitor. It will be appreciated that there are many ways to implement an electronic parking account. An example electronic parking account is described below with reference to FIG. 6. Typically, the electronic parking account includes a data field for the payment account identifier, which serves as the means for locating the respective electronic parking account for future transactions in the parking fee collection system 20. Then, in state 60, the in-parking terminal 32 allows the visitor to enter the parking facility 33. It will be appreciated that there are many means for allowing entry to the parking facility 22, such as taking no action that impedes entry or raising a gate arm that otherwise impedes entry.

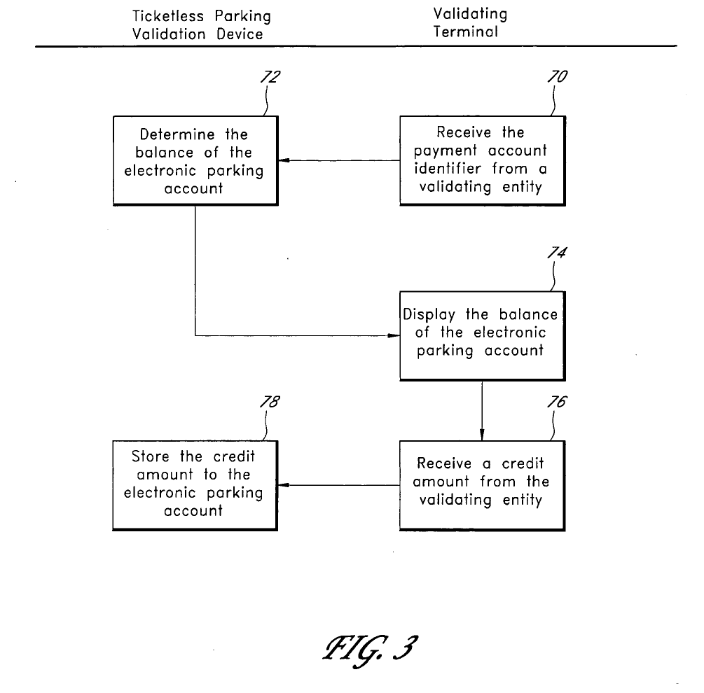

FIG. 3 illustrates the operation of various components in one embodiment of the invention when a validating entity credits the account of a parking visitor. The activities illustrated in FIG. 3 are divided between those actions by the ticketless parking validation device 30 and the validating terminals 36. In state 70, one of the validating terminals 36 receives the payment account identifier from the respective validating entity 24. Similar to the in-parking terminals, described with reference to FIG. 2, there are many ways to configure the validating terminals 36 to receive payment account identifiers, such as card readers, alphanumeric keypads, fingerprint scanners, iris pattern scanners, etc. Typically, the validating entity 24 uses the same means to enter the payment account identifier as the parking visitor uses to enter the payment account identifier at the in-parking terminal 32. Thus, for instance, if the parking visitor swiped a credit card through a magnetic card reader at the in-parking terminal 32, then the validating entity would typically swipe the visitor's same credit card through a magnetic reader at the validating terminal 36. Other configurations, however, are possible. For instance, the in-parking terminal 32 might be equipped with a card reader and the validating terminal 36 might be equipped with an alphanumeric keypad.

After receiving the respective visitor's payment account identifier, the validating terminal 36 communicates (described below with reference to FIG. 5) the payment account identifier to the ticketless parking validation device 30. In state 72, the ticketless parking validation device 30 determines the balance of the respective visitor's electronic parking account. Using the payment account identifier communicated by the respective validating terminal 32, the ticketless parking validation device 30 locates the corresponding electronic parking account. It will be appreciated that there are many methods for searching for a particular field in a collection of electronic data.

Once the respective electronic parking account is located, the ticketless parking validation device 30 determines the balance of the account. Typically, the balance is the unpaid amount of the parking fee incurred at the time the balance is determined, less any validating credit amounts. Thus, for instance, if the respective visitor had parked for two hours for a fee of ten dollars per hour and there were no accumulated credit amounts, then the balance of the electronic parking account would be twenty dollars. It will be appreciated that there are many ways to determine a parking fee. For instance, a parking fee collection system 20 may base a parking fee on an incremental basis, such as charging ten dollars an hour or five dollars per half hour. Alternatively, the parking fee collection service may base its fees on discrete amounts, such as a flat fee of ten dollars day or even ten dollars for an indefinite amount of time. Moreover, the parking fee collection service may base its fees on both incremental and discrete amounts. Many other fee schemes may be accommodated by alternative embodiments of the invention. Accordingly, the electronic parking account may be implemented in a variety of ways. An example electronic parking account is described below with reference to FIG. 6. In some embodiments, the parking fee is determined based on the information stored in the electronic parking account, such as the time when the visitor began parking in the parking facility 22. In other embodiments, the parking fee may be determined independently of any stored information.

After determining the account balance, the ticketless parking validation device 30 communicates (described below with reference to FIG. 5) the payment account identifier to the validating terminal 36. In state 74, the validating terminal 36 displays the balance of the electronic parking account for the respective visitor. It be will appreciated that there are many ways to display an account balance through a terminal device. The validating terminal 36 may be a modified card reader with an LCD display. Alternatively, the validating terminal may be a keypad terminal with an LCD display. In other embodiments, the validating terminal 36 may be a personal computer that may receive an account number from standard keyboard keys or from an attached card reader peripheral device. In still other embodiments, the validating terminal 36 may be a thin client processor connected to a central server through a network.

The account balance may be determined as a unit of time or as a unit of money. For example, if a visitor has parked for forty minutes, the account balance may appear as the amount of time parked, forty minutes, or as the fee for parking for forty minutes. As discussed above, a parking fee collection system 20 may determine the account balance based on incremental amounts of time or based on a discrete fee. Thus, for example, a visitor who has parked for forty minutes may have an account balance of four dollars if the parking fee charges one dollar for every increment of ten minutes.

In state 76, the validating terminal 36 receives a credit amount from the validating entity 24. The credit amount may be either a monetary amount or an amount of time. For instance, if the visitor has parked for one hour, the validating entity 24 might credit the visitor's account with thirty minutes of time. Alternatively, the validating entity 24 might credit the visitor's account with three dollars, representing thirty minutes of time with an associated fee of three dollars. Alternatively, the validating entity 24 may enter a special code that signals the parking fee collection system 20 to credit an entire accumulated fee. Thus, for instance, even if the visitor continued to park for another three hours, the visitor would be charged no fee for the remaining time by the parking fee collection system 20.

After receiving the amount of credit, the validating terminal 36 communicates (described below with reference to FIG. 5) the credit amount to the ticketless parking validation device 30. In state 78, the ticketless parking validation device 30 stores the credit amount to the visitor's account. It will be appreciated that there are many ways to keep a record of validating credit amounts. The electronic parking account may have additional fields for credit amounts. An example electronic parking account with additional fields for credit amounts is described below with reference to FIG. 5. In yet other embodiments, the account may automatically adjust the account balance to reflect the credit amount and store only the account balance. When another one of the validating entities 24 or the same one of the validating entities 24 queries the ticketless parking validation device 30 for the account balance, the ticketless parking validation device 30 typically takes into account all of the accumulated validating credit amounts. For instance, if the visitor had parked for a total of three hours and if two of the validating entities 24 had previously credited the visitor's account each with one hour of validation, then ticketless parking validation device 30 may determine that the account balance is one hour of time. As mentioned above, the account balance may be determined in terms of monetary values rather than amounts of time.

Although in the illustrated embodiment, the ticketless parking validation device 30 communicates the account balance to the respective validating terminal 36 before the respective validating terminal 36 communicates the validating credit amount to the ticketless parking validation device 30, in other embodiments, the validating terminals 36 may be configured to communicate the account payment identifier and the validating credit amount in succession without receiving any information from the ticketless parking validation device 30.

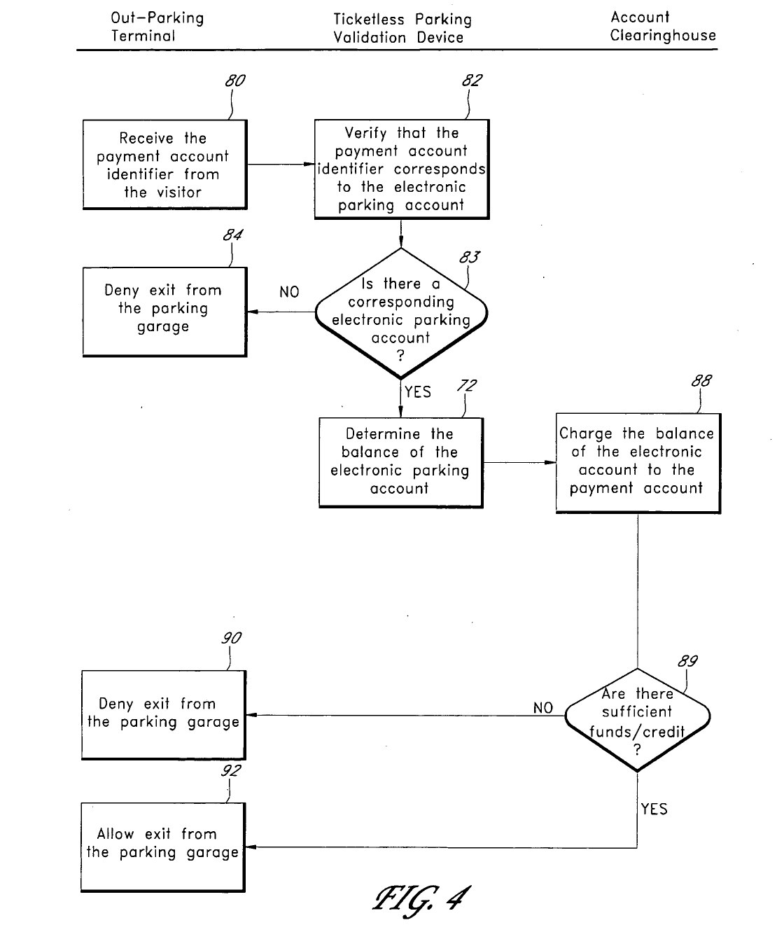

FIG. 4 illustrates the operation of various components in one embodiment of the invention when a parking visitor exits the parking facility. FIG. 4 illustrates the actions of the out-parking terminals 34, the ticketless parking validation device 30, and the account clearinghouse 38. In state 80, one of the out-parking terminals 34 receives a payment account identifier from a parking visitor. Similar to the in-parking terminals 32, the out-parking terminals may be configured in a variety of ways to receive a payment account identifier. Some of these variations were discussed above with reference to FIG. 2.

After receiving the payment account identifier, the out-parking terminal 32 communicates (described below with reference to FIG. 5) the payment account identifier to the ticketless parking validation device 30. In state 82, the ticketless parking validation device 30 verifies that the payment account identifier corresponds to an account previously created by the ticketless parking validation device 30. In other words, the ticketless parking validation device 30 verifies that the payment account identifier corresponds to an electronic parking account created when the visitor originally entered the parking facility 22. It will be appreciated that there are many ways to verify that the payment account identifier corresponds to an electronic parking account. For instance, the ticketless parking validation device 30 may implement a common search algorithm to compare the payment account identifier received from the out-parking terminal 34 with the payment account identifier field of each electronic parking account.

Decision block 83 represents the determination of the verification in state 82. If the payment account identifier is not valid, then, in state 84, the out-parking terminal 34 denies exit from the parking facility 22. Additionally, the out-parking terminal 34 may prompt the visitor for another payment account identifier, or otherwise instruct the visitor of alternative means for satisfying the incurred fee. As mentioned previously with reference to FIG. 1, the out-parking terminal may be configured to allow the visitor to exit regardless of whether or not a valid payment account identifier is entered. In these embodiments, the parking visitor is responsible for settling the account upon exiting, and exiting without paying the incurred fee is an unauthorized, though unimpeded, exit. Policing mechanisms may be implemented to prevent or discourage unauthorized exits. In yet other embodiments, the visitor may not be responsible for settling the account at the time of exit, but rather may be billed later by the parking fee collection system 20.

If, on the other hand, the account number received by the out-parking terminal 34 is valid, then the ticketless parking validation device 30 determines the total account balance. This is the same operation, state 72, that was described above with reference to FIG. 3. As mentioned with reference to FIG. 3, there are various ways in which an account balance may be determined. Typically, the final account balance will be determined in terms of monetary amounts. Furthermore, typically all of the accumulated credits are applied to determine the final balance. In some embodiments, however, the account balance is not adjusted by the accumulated credits. For instance, when the validating terminals 36 communicate directly with the account clearinghouse 38 (not shown), the account balance is merely the determination of the unpaid parking fee.

In some embodiments, the out-parking terminal 34 may be configured to request authorization from the user to charge the account to the account number previously received. If the user accepts the charge to the account number, then the out-parking terminal 34 may send the account balance to the ticketless parking validation device 30 which in turn sends the account number and the account balance to the account clearinghouse 38. Alternatively, if the visitor chooses not to charge the account balance to the first account number entered, the visitor may settle the account balance in another way. For instance, the visitor may use a different account number that may satisfy the account balance. This account number could be another credit card or debit card, may be a prepaid parking card, may be in the form of cash received through an automated cash receiver, or may be in the form of authorizing a bill for the incurred parking fee. It will be appreciated that there are many ways in which an out-parking terminal 34 may be configured to accept payment for the outstanding account balance.

After determining the final account balance, the ticketless parking validation device 30 communicates (described below with reference to FIG. 5) the final account balance for the identified payment account to the account clearinghouse 38 via the network 40. Although not illustrated, the communication typically occurs in a two-step process. The ticketless parking validation device first communicates the payment account identifier to the account clearinghouse 38. After receiving verification that the identified payment account is a valid account, similar to the process described above with reference to FIG. 2, the ticketless parking validation device 30 communicates the final account balance to the account clearinghouse 38. Alternatively, the ticketless parking validation device 30 may communicate both the payment account identifier and the account balance in the same related transaction. In this instance, the account clearinghouse 38 typically verifies that the identified payment account is valid before attempting to charge the account balance to the identified payment account.

In state 88, the account clearinghouse 38 charges the account balance to the identified payment account. It will be appreciated that the process for charging a payment account is commonly understood. If, for instance, the payment account identifier is a credit card number, then the account clearinghouse 38 charges the account balance to the credit account corresponding to the credit card number. If, alternatively, the payment account identifier is a prepaid card number, then the account clearinghouse 38 debits the account balance from the prepaid account. As described above with reference to FIG. 1, the account clearinghouse 38 may be implemented in a variety of ways or not implemented at all.

Decision block 89 represents the determination of sufficient funds in state 88. If there are insufficient funds and/or credit available then, in state 90, the out-parking terminal 34 denies the visitor from exiting the parking facility 22. The out-parking terminal 34 is notified of the sufficiency of funds and/or credit by the ticketless parking validation device 30, which is notified by the account clearinghouse 38. In some embodiments, the out-parking terminal 34 may, after receiving notification of insufficient funds and/or credit, prompt the parking visitor to settle the balance with an alternative payment account. For instance, if there is insufficient credit available to a visitor's credit card account, the parking visitor may enter another account number, such as a credit, debit, or prepaid card number. Alternatively, the out-parking terminal 34 may be configured to receive cash or send a bill for the parking fee. It will be appreciated that the out-parking terminal 34 may be configured in manner such that it can automatically settle a parking visitor's account balance. In some embodiments, the system 20 may be configured to place a hold on the visitor's debit or credit card for a specific monetary amount in an effort to ensure that sufficient funds or credit are available prior to permitting entry to the parking facility 22

If, on the other hand, there are sufficient funds and/or credit available to the account then, in state 92, the out-parking terminal 34 allows the visitor to exit from the parking facility 22. As discussed with reference to FIG. 1, the out-parking terminal 34 may be configured to remove a barrier impeding the parking visitor's exit or may take no action at all because the out-parking terminal is configured not to impede exit. Alternatively, the parking fee collection system 20 may be implemented without separate out-parking terminals 34, employing instead a single type of terminal that performs the combined operations of the in-parking terminals 32 and the out-parking terminals described in the embodiments illustrated by FIGS. 1 through 6.

FIG. 5 illustrates the flow of information in one embodiment of the invention. One of the in-parking terminals 32 communicates the payment account identifier to the ticketless parking validation device 30, which, in turn, communicates the payment account identifier to the account clearinghouse 38. The account clearinghouse 38 then communicates to the ticketless parking validation device 30 whether the identified payment account is valid, which, in turn, communicates the same information to one of the in-parking terminals 32. Preferably, this completes the flow of information during the entry stage.

During the validation stage, one of the validating terminals 36 communicates the received payment account identifier to the ticketless parking validation device 30. The ticketless parking validation device 30 then communicates the account balance to the respective validating terminal 36. The respective validating terminal 36 then communicates to the ticketless parking validation device 30 a validating credit amount. Preferably, this completes the flow of information during the validation stage.

During the exit stage, one of the out-parking terminals 34 communicates the received payment account identifier to the ticketless parking validation device 30, which, in turn, communicates the payment account identifier to the account clearinghouse 38. In addition, the ticketless parking validation device 30 communicates the final account balance to the account clearinghouse 38. Then the account clearinghouse 38 communicates to the ticketless parking validation device 30 whether there are sufficient funds and/or credit to charge the account balance to the identified payment account, which, in turn, communicates the same information to one of the out-parking terminals 34. Preferably, this completes the flow of information during the exit stage.

Although in the illustrated embodiment the ticketless parking validation device 30 is depicted as a single computing device, it will be appreciated that the ticketless parking validation device 30 may be implemented in a variety of configurations. The ticketless parking validation device 30 may, for example, be implemented as a networked group of different computing components that collectively execute the functions described in FIGS. 1 through 6. Thus, the ticketless parking validation device 30 may be multiple devices. Alternatively, the ticketless parking validation device 30 may operate on the same physical machine as the in-parking terminals 32, the out-parking terminals 34, or the validating terminals 36. Thus, the ticketless parking validation device 30 may be implemented as a set of functions on another device. The use of the term “device,” therefore, is not intended to limit the scope of possible implementations for the associated functions attributed in FIGS. 1 through 6 to the ticketless parking validation device 30.

The in-parking terminals 32, out-parking terminals 34, and validating terminals 36 all communicate with the ticketless parking validation device 30. These communications may be implemented in any form of electronic transmission, including wired or wireless communication. Thus, the in-parking terminals 32, the out-parking terminals 34, and the validating terminals 36 and may be configured to communicate with the ticketless parking validation device 30 via dedicated or shared cable connections, telephone lines, radio frequency, Bluetooth wireless transmission, satellite communication, any combination of the above, or any other means for communicating information electronically. Additionally, the means of communication may be different for the in-parking terminals 32, the out-parking terminals 34, and the validating terminals 36. For example, the in-parking terminals may be configured to communicate via wired communications and the validating terminals 36 may be configured to communicate via wireless communication. Moreover, each respective terminal may be configured for different communications. Thus, for example, one of the in-parking terminals 32 may be configured to communicate via wired communication and other terminals may be configured for wireless communication.

The ticketless parking validation device 30 communicates with the account clearinghouse 38 via the network 40. The network 40 may be any communication network, such as the Internet, a dedicated network, LAN, WAN, telephone network, satellite transmission network, any combination of the above, or any other means for connecting remote systems over a network for transmitting electronic information.

FIG. 6 illustrates the data components in one embodiment of an electronic parking account that may be used to implement the invention. There are four snapshots describing the status of the illustrated electronic parking account. Each snapshot corresponds to a time indicated on the left-hand side. Each snapshot also corresponds to a specific action described in one of the flowcharts illustrated in FIGS. 2 through 4. These actions are noted in the right-hand side. The first status snapshot 100 illustrates information stored at the time of state 58, when an electronic parking account is first created. The illustrated electronic parking account comprises the payment account identifier for the respective visitor. In the illustrated embodiment, the payment account identifier is the account number 123456789, which may correspond, for example, to a credit card number. Additionally, the illustrated electronic parking account comprises other information, including the in-parking terminal lane through which the visitor entered the parking facility. For instance, in the illustrated embodiment, the visitor entered the in-parking terminal corresponding to lane 3. The illustrated electronic parking account also comprises the date of entry as well as the time of entry. Finally, the illustrated electronic parking account comprises fields for determining the incurred parking fee. Thus, there is a field for a fee rate, which is ten dollars per hour in the illustrated embodiment, a gross fee, validating credit amounts, and a total fee. In other embodiments, however, some or all of these fee fields may not necessarily be stored with each electronic parking account data object. Thus, the fee rate may be specified, for instance, as a constant value that need not be kept within a field for each individual electronic parking account, and it may be unnecessary, for example, to store data values for the gross and total fees. Specifically, the fee rate may be kept as a constant variable, the electronic parking account data objects may be created dynamically as visitors enter the parking facility 22 and parking accounts are created in state 58, and the determinations of the gross and total fees may be determined on the fly and stored in temporary data objects separate from the electronic parking accounts.

The second snapshot 102 illustrates the status of the electronic parking account two hours after the visitor has entered the parking facility 22. The information recorded in the electronic parking account has remained the same. The illustrated snapshot is the hypothetical status of the electronic parking account just before one of the validating entities 24 communicates a validating credit amount for an electronic parking account. As described above with reference to FIG. 3, prior to communicating a validating credit amount, one of the validating entities 24 communicates, through the corresponding validating terminal 36, the visitor's payment account identifier to the ticketless parking validation device 30. In response, the ticketless parking validation device 30 searches for the electronic parking account corresponding to the communicated payment account identifier. Upon locating the corresponding electronic parking account, the ticketless parking validation device 30 determines the account balance, which is the operation of state 72, as indicated in the right-hand side. In the illustrated embodiment, the ticketless parking validation device 30 determines from the start time and the fee rate that the account balance is presently twenty dollars. Alternatively, the ticketless parking validation device 30 might determine that the current account balance is two hours.

The third snapshot 104 illustrates the status of the electronic parking account after the respective validating entity 24 has credited the visitor's parking account with a validating credit amount. In addition to the information already stored in the parking account, the electronic parking account corresponding to the payment account identifier, number 123456789, additionally comprises a credit amount of ten dollars. The gross fee remains twenty dollars, representing two hours of parking time at ten dollars per hour, but the total fee is adjusted to ten dollars, representing the difference between the unadjusted (gross) fee and the validating credit amount.

The ellipsis between the third snapshot 104 and the fourth snapshot 106 illustrate that other transactions have occurred between the two snapshots. The fourth snapshot 106 illustrates the status of the electronic parking account four hours after the visitor entered the parking facility 22. As illustrated, the ticketless parking validation device 30 is responding to a query to determine the account balance. The illustrated snapshot is the hypothetical status of the electronic parking account at the moment when the visitor attempts to exit the parking facility 22 through one of the out-parking terminals 34. In the illustrated embodiment, the visitor's electronic parking account balance is fifteen dollars. The visitor has parked for four hours at a rate of ten dollars per hour, yielding an unadjusted (gross) fee of forty dollars. The visitor, however, has received a total of twenty five dollars of validating credit from three different vendors (or perhaps three transactions with the same vendor, or some combination of multiple transactions and multiple vendors). Thus, the adjusted (total) fee is only fifteen dollars. Accordingly, the ticketless parking validation device would communicate the account balance of fifteen dollars to the account clearinghouse 38 in an attempt to charge the balance to the identified payment account, number 123456789, in satisfaction of the incurred parking fee of fifteen dollars.

Although the electronic parking account in the illustrated embodiment contemplates storing all of the relevant information for a particular transaction in a centralized data object, it will be appreciated that an electronic parking account may take many different forms. For instance, an electronic parking account may consist of separate, individual fields in a relational database. In this sense, the electronic parking account is a conceptual account—that is, an account consisting of data elements conceptually related to one another, regardless of their physical or logical connection. An electronic parking account, then, may be any identifiable data associated with a particular parking transaction. In some embodiments, an electronic payment account may comprise a payment account identifier, and the payment account identifier may, in addition to identifying the account from which to charge the incurred parking fee, also identify the electronic parking account that stores the information for each parking transaction.

Although this invention has been described in terms of certain embodiments, other embodiments that are apparent to those of ordinary skill in the art, including embodiments which do not provide all of the benefits and features set forth herein, are also within the scope of this invention. For example, although certain preferred components of the system 20 and certain preferred operational steps have been shown and described, it is not necessary for all of the described components and steps to be present in every embodiment. Accordingly, the scope of the present invention is defined only by reference to the appended claims.

What is claimed is:

1. A method implementing ticketless parking validation, the method comprising:
creating an electronic parking account associated with a use of a parking facility;
electronically storing at least one validating credit amount originating from a validating entity; and
associating the at least one validating credit amount with the electronic parking account as a result of the validating entity providing an identifier for the electronic parking account.

2. The method of claim 1, further comprising apprising a validating entity of information associated with the electronic parking account.

3. The method of claim 1, wherein the identifier for the electronic parking account is a unique number, fingerprint, voice pattern, or retinal pattern.

4. A method implementing parking validation for an automatic parking facility, the method comprising:
receiving automatically a payment account identifier in connection with a user's use of an automatic parking facility;
determining an unadjusted fee for the user's use of the parking facility;
receiving automatically at least one validating credit amount; and
determining at least one adjusted fee for the user's use of the parking facility based on the at least one validating credit amount and on the unadjusted fee for the user's use of the parking facility.

5. The method of claim 4, wherein the payment account identifier is a credit, debit, or credit/debit card number, and wherein receiving automatically a payment account identifier comprises receiving the credit, debit, or credit/debit card number via an automatic card reader.

6. The method of claim 5, further comprising verifying the payment account identifier with the assistance of a credit/debit account clearinghouse as a precondition for permitting the user to use the parking facility.

7. The method of claim 4, wherein receiving automatically a payment account identifier comprises receiving a unique identifier from a device equipped to read one of the following: PIN numbers, magnetic strips, bar codes, infrared signals, telephonic signals, radio frequencies, embedded microprocessors, embedded transmitters, fingerprints, voice patterns, and iris patterns.

8. The method of claim 4, further comprising charging the adjusted fee to the payment account identifier as a condition for permitting the user to use the parking facility.

9. The method of claim 4, wherein receiving automatically at least one validating credit amount comprises receiving the at least one validating credit amount via a terminal equipped with an automatic card reader.

10. The method of claim 4, further comprising apprising a validating entity of at least one of the following: the unadjusted fee and the adjusted fee.

11. A system for implementing ticketless parking validation, the system comprising:
at least a first parking terminal, wherein the first parking terminal is configured to receive and to communicate at least one payment account identifier associated with at least one use of a parking facility;
at least a first validating terminal, wherein the first validating terminal is configured to receive and to communicate the at least one payment account identifier and at least one credit amount associated with the at least one payment account identifier; and
a ticketless parking validation device in data communication with the at least first parking terminal and with the at least first validating terminal, the ticketless parking validation device being configured to receive from the at least first parking terminal the at least one payment account identifier, and being further configured to receive from the at least first validating terminal the at least one payment account identifier and the at least one credit amount.

12. The system of claim 11, wherein being configured to receive from the first parking terminal comprises being configured to receive from the first parking terminal by means of electronic transmission.

13. The system of claim 11, wherein being configured to receive from the first validating terminal comprises being configured to receive from the first validating terminal by means of electronic transmission.

14. The system of claim 11, wherein the at least one payment account identifier is a credit, debit, or credit/debit card number.

15. The system of claim 11, wherein the ticketless parking validation device is further configured to communicate to an account collection service the payment account identifier and a parking fee amount.

16. The system of claim 15, wherein the account collection service is a credit/debit account clearinghouse.

17. The system of claim 11, wherein the ticketless parking validation device is further configured to communicate to the plurality of validating terminals a parking fee amount associated with the at least one payment account identifier.

18. The system of claim 17, wherein the first validating terminal is further configured to receive and to display the parking fee amount.

19. The system of claim 11, wherein the ticketless parking validation device is further configured to communicate to the plurality of parking terminals a parking fee amount associated with the at least one account identifier.

20. The system of claim 19, wherein the first parking terminal is further configured to receive and to display the parking fee amount.

21. The system of claim 20, wherein the plurality of parking terminals further comprises a second parking terminal, the second parking terminal being configured to receive and to display the parking fee amount.
